(19) United States
(12) Patent Application Publication
(10) Pub. No.: US 2023/0024674 A1
(43) Pub. Date: Jan. 26, 2023

(54) AUXILIARY ELECTRIC HEATING SYSTEM FOR COMPRESSED NATURAL GAS (CNG) VEHICLE

(71) Applicant: Wegmans Food Markets, Inc., Rochester, NY (US)

(72) Inventors: Greg Bennett, Ionia, NY (US); Matt Harris, Webster, NY (US)

(21) Appl. No.: 17/871,323

(22) Filed: Jul. 22, 2022

Related U.S. Application Data
(60) Provisional application No. 63/225,256, filed on Jul. 23, 2021.

(51) Int. Cl. B60H 1/03; B60H 1/00

(52) U.S. Cl. CPC B60H 1/034; B60H 1/00807; B60H 1/00885; B60H 1/00985; B60H 1/00328

(57) ABSTRACT

An electric auxiliary heating system for a natural gas powered vehicle having a natural gas engine is provided to maintain a cab temperature upon cessation of operation of the natural gas engine. The present system selectively circulates previously heated coolant to an existing cab heating circuit to maintain a desired cab temperature, wherein upon the coolant temperate cooling to a predetermined temperature the auxiliary heating system initiates heating with electric heaters in a reservoir to provide heating of the coolant. A controller provides for the initiation and termination of the auxiliary heating corresponding to selected predetermined thresholds as well as a sensed oil pressure generated by the natural gas engine.

### CROSS-REFERENCE TO RELATED APPLICATIONS

The present application claims the benefit of U.S. Provisional Patent application 63/225,256 filed Jul. 23, 2021 and entitled AUXILIARY ELECTRIC HEATING SYSTEM FOR COMPRESSED NATURAL GAS (CNG) VEHICLE, the entire disclosure of which is hereby expressly incorporated by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A SEQUENCE LISTING

Not applicable.

### BACKGROUND OF THE INVENTION

### Field of the Invention

The present disclosure related to auxiliary heating systems and particularly to electric auxiliary heating systems for a natural gas powered vehicle and more particularly to electric auxiliary heating systems for a compressed natural gas (CNG) powered vehicle.

### Description of the Related Art

Internal combustion motor vehicles employ discharge heat from the engine to heat a cab of the vehicle. These systems circulate engine coolant from the engine to a heat exchanger in the cab and back to the engine. Coolant heated by the running vehicle engine transfers heat to the cab through the heat exchanger and a fan associated with the cab. However, there is no heat provided to the cab when the engine is turned off. One way to provide cold weather heating for the cab is by allowing the engine to idle while the vehicle is parked, thereby keeping the engine coolant sufficiently hot for heating the cab. However, this is wasteful of fuel because it necessitates running the engine.

In addition to wasting fuel, idle time contributes to premature engine wear, and increases preventative maintenance frequency on vehicles. For example, one hour of idle time is equivalent to approximately 30-40 miles of engine wear. Further, in some areas idling for any period of time is illegal. Inter-trip idle is defined as any idle time recorded in a truck that occurs when parked and the engine is left running This occurs most often behind stores, at distribution centers, or backhaul facilities, where loiter time can be lengthy. Inter-trip idle excludes time recorded in traffic, at stop lights, or any time not in park.

Inter-trip idle is behavior based and correctable with coaching and a mechanical solution to incentivize turning off the truck. However, this does not address the problem of providing a comfortable temperature for drivers when the vehicle is turned off.

Current compressed natural gas vehicles typically use diesel fueled supplemental heaters. These supplemental heaters combust the diesel fuel to heat the engine coolant, without requiring running of the truck engine. However, this solution requires a second combustion system as well as fuel tank. Additional fuel tanks make these systems difficult to install and less convenient because the driver must refill two types of fuel.

Therefore, the need exists for an auxiliary coolant heater for CNG vehicles and particularly an electric auxiliary coolant heater for selectively or automatically maintaining a cab temperature.

### BRIEF SUMMARY OF THE INVENTION

Generally, the present disclosure provides a viable option for drivers to maintain given coolant temperatures in a CNG powered truck, wherein the axillary heat does not consume CNG.

In one configuration, the present disclosure provides an auxiliary heating system for a vehicle having a natural gas (NG) engine, a coolant jacket thermally coupled to the NG engine, a cab heat exchanger thermally connected to a cab, the auxiliary heating system including a reservoir; an electric heater thermally coupled to the reservoir; an engine coolant supply line fluidly connecting the coolant jacket and the reservoir; a line valve in the engine coolant supply line; a heated coolant line fluidly connecting the reservoir to the cab heat exchanger; a pump fluidly connected to the heated coolant line to selectively transfer coolant from the reservoir to the heated coolant line and the cab heat exchanger; a control valve; an engine coolant return line fluidly connecting the control valve and the coolant jacket; a cold return line fluidly connecting the cab heat exchanger to the control valve; an introduction line fluidly connecting the control valve to the reservoir; a temperature sensor configured to sense a temperature of the coolant in at least one of the reservoir, the engine coolant supply line, the heated coolant line, or the cab; and a controller connected to the temperature sensor and the control valve, the controller configured to cease operation of the pump upon the NG engine generating a predetermined oil pressure.

The present disclosure further provides a method of heating a cab in a vehicle having a natural gas (NG) engine, a coolant jacket thermally coupled to the NG engine, and a cab heat exchanger thermally connected to the cab, the method including sensing a temperature of a coolant heated by the NG engine; upon the sensed temperature dropping to a predetermined level, supplying electric power to an electric heater in a reservoir; actuating a pump fluidly connected to the reservoir to circulate the heated coolant to the cab heat exchanger; and setting the control valve to recirculate at least a portion of the coolant from the cab heat exchanger to the reservoir.

### BRIEF DESCRIPTION OF THE SEVERAL VIEWS OF THE DRAWING(S)

FIG. 1 is a schematic of the present auxiliary heater system and a CNG engine.

FIG. 2 is an enlarged schematic of the system 100 of FIG. 1.

FIG. 3 is the schematic of FIG. 1 with annotated flow lines.

FIG. 4 is a partial cut away perspective view of a configuration of the axially heater.

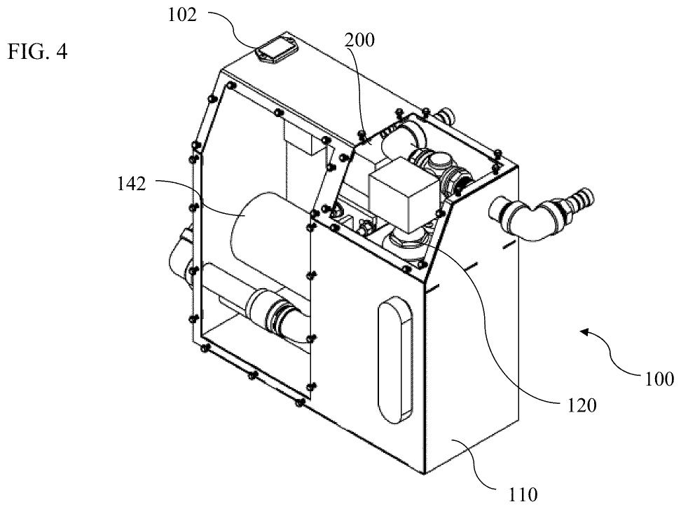

### DETAILED DESCRIPTION OF THE INVENTION

The present disclosure provides an auxiliary heating system 100 for a vehicle having a natural gas engine 10, wherein in one configuration the natural gas engine is a compressed natural gas (CNG) engine. While the description is set forth in terms of the CNG engine, it is understood the engine could be any type of natural gas engine. The CNG engine 10 employs natural gas from an on-board fuel tank, or cylinder. The CNG fuel system transfers high-pressure gas from the fuel tank through the fuel lines to a pressure regulator. The pressure regulator reduces the pressure of the natural gas to a level compatible with a fuel injection system of the CNG engine 10. The reduced pressure gas is then introduced into an intake manifold or combustion chamber, where the natural gas mixes with air, is compressed and then ignited by a spark plug, wherein waste heat is captured by a coolant circulating through a coolant jacket 12 of the engine 10.

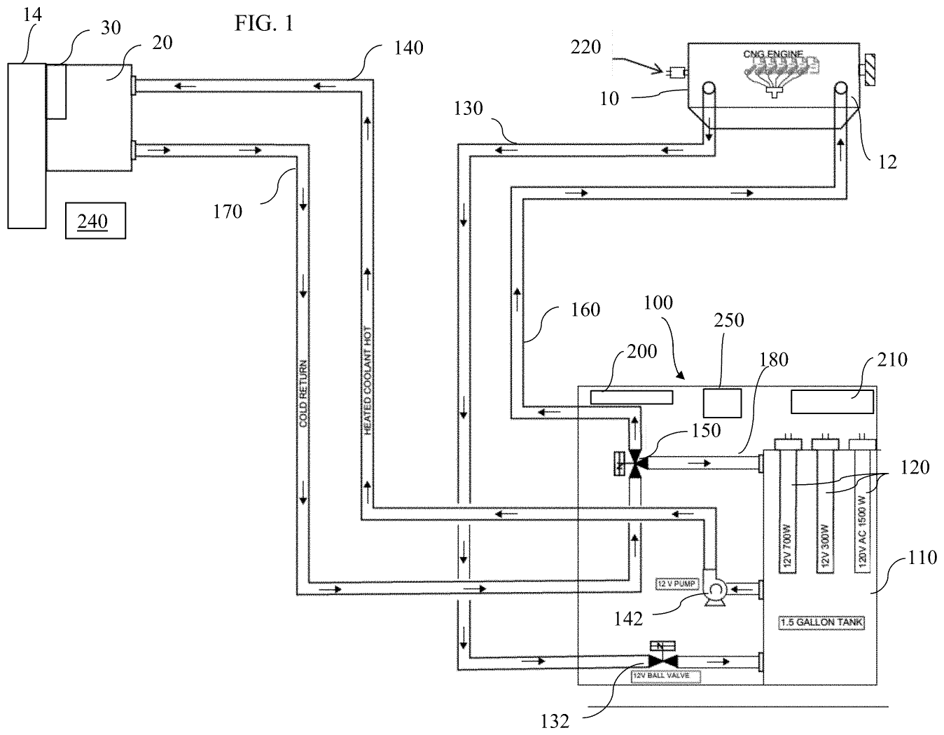

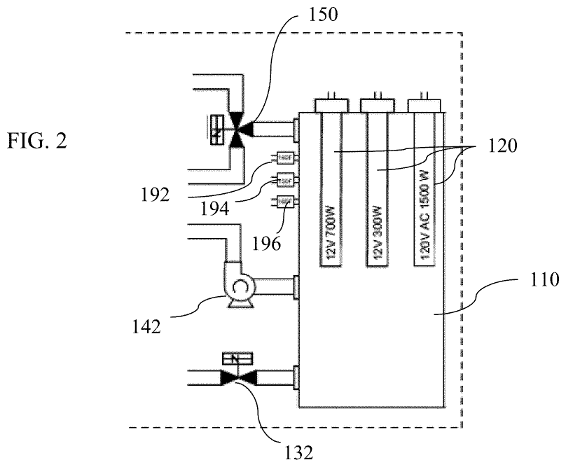

Referring to FIGS. 1 and 2, the present system 100 cooperates with a vehicle having the CNG engine 100 and a truck heater core 20, which can be any of a variety of configurations. For purposes of description, the term “cab” includes any passenger or operator compartment, including an operation or an accommodation space. The term “vehicle” is intended to encompass any type of powered vehicle including but not limited to trucks, passenger vehicles, recreational vehicles as well as tractors and motor vehicles with a main power source, such as an internal combustion engine and particularly the natural gas engine, that has the primary function of propelling the vehicle.

The vehicle includes a coolant loop that fluidly connects the CNG engine 10, a vehicle radiator and the truck heater core 20, as known in the art. The truck heater core 20 includes a cab heat exchanger 30 for cooling or heating a cab 14 corresponding to the temperature of the coolant supplied to the truck heater core. Thus, the term truck heater core 20 encompasses the manufacturer's truck heater core as well as the subcomponents which may be individually employed, such as the cab heat exchanger 30 for transferring heat between the cab and the coolant.

Referring to FIGS. 1 and 2, the present system 100 includes a reservoir 110; an electric heater 120 thermally coupled to or in the reservoir; an engine coolant supply line 130; a line valve 132 in the engine coolant supply line; a heated coolant supply line 140; a pump 142; a control valve 150; an engine coolant return line 160; a cold return line 170; an introduction line 180; a temperature sensor 190; and a controller 200 connected to at least the electric heater, the temperature sensor, and the control valve.

A power supply 210 is also incorporated into the present system 100 for providing the necessary electric power. The power supply 210 can be any of a variety of commercially available batteries, which in one configuration are rechargeable. The recharging of the power supply 210 can be by wired connection to a power grid, solar powered, as well as additional batteries. Thus, the power supply 210 encompasses rechargeable batteries such as lithium ion batteries, and/or 12 volt solar powered rechargeable batteries. In one configuration, the power supply 210 includes 4 rechargeable 12 volt batteries. It is further understood the vehicle can carry at least one solar panel for generating electricity, as known in the art, wherein the solar panel is operably connected to the power supply 210, such as the batteries to selectively charge the batteries.

Referring again to FIGS. 1 and 2, the reservoir 110 is configured to retain a volume of coolant and is selectively incorporated into or separated from the coolant loop of the vehicle via the line valve 132. The volume of coolant retained by the reservoir 110 is selected to provide a heat source for selectively heating the cab for predetermined time to a predetermined temperature for a given ambient temperature. While the volume of the reservoir 110 is dependent on a number of factors including volume of the vehicle coolant loop as well as the specific heaters, in one configuration the reservoir has a volume between 1 gallon and 5 gallons, and in a further configuration has a volume between 1 gallon and 2 gallons, with a satisfactory volume of 1.5 gallons. Alternatively stated, in one configuration the reservoir 110 is at least 5% of the volume of the coolant in the vehicle coolant loop and can be as much as 25% of the volume of the vehicle coolant loop. It is believed a reservoir 110 volume between approximately 10% and 20% of the volume of the vehicle coolant loop is satisfactory. It is understood the vehicle coolant loop can include the engine coolant supply line 130, the heated coolant line 140, the cold return line 170 and the engine coolant return line 160.

The reservoir 110 includes or is thermally coupled to at least one electric heater 120. In one configuration, the reservoir 110 includes or is thermally coupled to two electric heaters 120, such as a 12 volt heater and a 120 volt heater. In a further configuration, the reservoir 110 includes or is thermally coupled to two DC heaters 120, such as a submersible 12 volt DC 700 watt heater and a submersible 12 volt 300 watt heater, and a submersible AC heater such as a 120 volt 1500 watt heater, wherein each heater is connected to the controller 200. The electric heaters 120 are resistance heaters converting electric energy into thermal energy.

The reservoir 110 includes a plurality of switches, such as temperature switches, corresponding to the number of heaters in the reservoir and connected to the controller 200. As seen in FIGS. 1 and 2, in one configuration, the reservoir 110 includes 140° F. switch 192 which turns on the 12 volt heater to heat the coolant in the reservoir and circulate the heated coolant to the cab. The reservoir 110 further includes a 150° F. switch 194 which turns off the 12 volt heater and a 160° F. switch 196 which turns off the AC heater, such as the 120 volt 1500 watt heater.

The engine coolant supply line 130 fluidly connects the coolant jacket 12 and the reservoir 110, wherein the engine coolant supply line includes the line valve 132 configured to selectively permit or preclude fluid passage from the coolant jacket to the reservoir. In one configuration, the line valve 132 is operably connected to the controller 200 and is a 12 volt motorized ball valve, as known in the art.

The heated coolant supply line 140 fluidly connects the reservoir 110 to the truck heater core 20, and thus to the cab heat exchanger 30 for transferring heat between the coolant and the cab. The pump 142 is connected to the heated coolant supply line 140 for selectively circulating coolant from the reservoir 110 through the truck heater core 20 and to the control valve 150. The pump 142 is connected to the controller 200 and can be selectively actuated through the controller. The pump 142 has an operative state imparting circulation of the coolant through at least the heated coolant line 140, the cold return line 170, the introduction line 180, and the reservoir 110, and an inoperative state wherein the pump does not impart motive flow to the coolant. In one configuration, the pump 142 is a 12 volt pump, and thus can be battery driven, such as by the power supply 210. A further feature of the pump 142 includes configuring the pump as a centrifugal pump which allows for the passage of coolant through the pump when the pump is not operating. Thus, if the vehicle is running, and the vehicle, such as via the NG engine 12, is circulating coolant from the coolant jacket 12 through the engine coolant supply line 130, the heated coolant line 140, the cold return line 170, and the engine coolant return line 160, and the present system 100 is off, the pump 142 is in an inoperative state, not being powered by the system 100, but the pump allows vehicle imparted circulation of the coolant through the pump. Thus, isolating valving is not required for the pump 142. The absence of this valving reduces the weight and cost of the system 100. Further, upon the vehicle being off and the present system 100 is on, actuation of the pump will impart the necessary flow through the heated coolant supply line 140 (as well as the reservoir 110 and the cold return line 170). The pump 142 is either configured to or be operated at parameters to provide an approximately 5 gallon per minute flow of the coolant.

The control valve 150 is fluidly connected to the engine coolant return line 160, the cold return line 170 and the introduction line 180. In addition, in one configuration, the control valve 150 is connected to the controller 200, wherein the controller can dispose the control valve in any of a variety of operating positions as set forth below. A satisfactory control valve 150 is believed to be a 3-way valve as known in the art.

The engine coolant return line 160 fluidly connects the control valve 150 and the coolant jacket 12.

The cold return line 170 fluidly connects the truck heater core 20 and specifically the cab heat exchanger 30 to the control valve 150.

The introduction line 180 fluidly connects the control valve 150 to the reservoir 110. Thus, the control valve 150 can selectively direct the flow of coolant, whereby coolant can be selectively diverted from the cold return line 170 to either or a combination of the engine coolant return line 160 and the introduction line 180.

The temperature sensor 190 is configured to sense a temperature of the coolant in at least one of the coolant jacket 12, the engine coolant supply line 130, the introduction line 180, the heated coolant line 140, or the reservoir 110. It is contemplated that a separate temperature sensor 190 can be located to monitor the temperature in each of these locations, wherein the temperature sensors are connected to the controller 200.

A sensor 220 is connected to the CNG engine 10 for sensing an oil pressure in the CNG engine 10. Thus, in one configuration, the sensor 220 is a pressure switch, such as a 12 volt oil pressure switch, which is connected to the CNG engine 10 as well as the vehicle power system and thus can selectively provide or terminate power to the system 100, such as each of the valves, relays and switches.

The controller 200 is connected the components as set forth above as well as to the power supply 210. Depending on the specific configuration, the power to each of the components can pass through the controller 200 or can be merely regulated or switched by the controller. The controller 200 can include a user interface 240 within the cab, as well as external to the vehicle, for permitted external control. The user interface 240 can be located on the controller 200 or remote from the controller, such as a touch pad accessible by the operator of the vehicle.

The controller 200 is configured to turn off the electric heaters 120 and the pump 142 upon the sensor 220 registering an oil pressure above a given level, such as 15 pounds per square inch (psi), indicating the engine 10 is operating. That is, operation of the engine 10 generates an oil pressure at the sensor 220 of at least 15 psi, which automatically shuts off the present system 100. In addition, the controller 200 can selectively operate the control valve 150 depending upon whether the coolant from the engine 10 is cooling off the cab and needs to be heated. For example, the controller 200 can be configured to provide that upon turning the engine 10 off, wherein the coolant temperature is approximately 200° F., when the coolant temperature is within a first range, such as for example, from 200° F. to 150° F., the coolant in the vehicle coolant system is cycled through to the truck heater core 20 (and the cab heat exchanger 30), thereby employing the residual heat from the engine 10 as the heat source. Further, when the coolant temperature is within a second range, such as for example, from 150° F. to 140° F., the coolant is cycled through the reservoir 110 to be heated by the electric heaters 120.

It is further contemplated the present system 100 can include wireless communications 250, such as Bluetooth communication, among the controller 200, the battery chargers, the sensors 190, 192, 194, 196 as well as the power supply 210, such as the batteries. Thus, the operational health of the system 100 can be monitored remotely. For example, the charge rate and discharge rate of the power supply 210, such as the batteries can be monitored and thus controlled for increasing or maximizing the operational life span of the power supply 210, such as the batteries.

In one configuration, the vehicle coolant system has an approximately 13 gallon volume. During operation of the engine 10, this volume of coolant is brought to approximately 200° F. When the engine 10 is turned off, the pump 142 of the present system 100 circulates the coolant from the engine coolant jacket 12, through the engine coolant supply line 130, the reservoir 110, the heated coolant supply 140 and to the cab heat exchanger 30, thereby heating the cab. This circulation can continue until the coolant cools to a predetermined coolant temperature, such as for example 160° F. When the temperature sensors 190 indicate the coolant temperature has dropped to, or below this predetermined temperature, the controller 200 initiates the electric heaters 120 which are run to maintain the coolant temperature between 150° F. and 160° F. It is contemplated this circulation can selectively include circulating the coolant through the engine coolant jacket 12 as well as the truck heater core 20 and cab heat exchanger 30. In one configuration, if the coolant temperature drops below 150° F., the coolant heated in the reservoir 110 is circulated only to the truck heater core 20 (the cab heat exchanger 30), and the engine coolant jacket 12 is bypassed. This preferential heating allows the present system 100 to maintain a temperature in the cab over a longer period of time, as the system is not using energy to heat the engine 10 via the coolant jacket 12. A further preferential heating feature is the circulation of the heater coolant through the truck heater core 20 and cab heat exchanger 30, prior to passing to the coolant jacket 12. That is, even if the coolant heated by the electric heaters 120 is used to heat the engine 10 via the coolant jacket 12, the heated coolant first passes through the truck heater core 20 (the cab heat exchanger 30), thereby providing the operator to employ the available heat as desired prior to the heat passing to the coolant jacket 12.

In a further configuration, if the engine 10 is cold, the controller 200 can turn the 12 volt electric heater 120 on (as well as the 110/120 volt heater if grid power is available), wherein only the volume of coolant in the reservoir 110 is heated. This heated volume of coolant can then be circulated to the truck heater core 20 and cab heat exchanger 30, without passing the heated coolant to the coolant jacket 12. That is, the electrically heated coolant passes from reservoir 110 through the heated coolant line 140, through the truck heater core 20 (the cab heat exchanger 30), then back through the cold return line 170 to the control valve 150, which diverts the entire flow to the introduction line 180 and hence back to the reservoir—without passing through the coolant jacket 12. This provides for preferential heating by the controller 200. If the electric heaters 120 heat the coolant to a predetermined level, such as at least 150° F., the controller 200 can dispose the control valve 150 to circulate the heated coolant to the truck heater core 20 (and cab heat exchanger 30) as well as the coolant jacket 12. It is contemplated the controller 200 can then turn off one of the electric heaters 120 when the coolant is heated to a predetermined temperature. For example, once the coolant is heated to above 150° F., the 12 volt electric heater 120 can be turned off and when the coolant temperature is 160° F., the 120 volt heater can be turned off Thus, the controller 200 can selectively employ electric heaters 120 powered by the power supply 210 or powered by an available connection to a grid.

It is further contemplated that the controller 200 can be configured to ensure the coolant temperature does not drop below a cold start engine temperature for the CNG engine 10. That is, when the CNG engine 10 temperature is below a predetermined cold start engine temperature, extra fuel is required in order to start the CNG engine. Thus, fuel savings can be obtained by maintaining the CNG engine 10 temperature above the cold start temperature. In one configuration, the controller 200 is configured to operate the electric heaters 120 such that the coolant is maintained above 140° F. to avoid requiring a cold start of the CNG engine 10.

Thus, the present disclosure provides an auxiliary heating system 100 for a vehicle having a CNG engine 10, a coolant jacket 12 thermally coupled to the CNG engine, a cab and cab heat exchanger 30 thermally coupled to the cab, wherein the auxiliary heating system includes (a) a reservoir 110; (b) at least one electric heater 120 in the reservoir; (c) an engine coolant supply line 130 fluidly connecting the coolant jacket and the reservoir; (d) a line valve 132 in the engine coolant supply line; (e) a heated coolant line 140 fluidly connecting the reservoir to the cab exchanger; (f) a pump 142 fluidly connected to the heated coolant line to selectively transfer coolant from the reservoir to the heated coolant line and the radiator, or heat exchanger; (g) a control valve 150; (h) an engine coolant return line 160 fluidly connecting the control valve and the coolant jacket; (i) a cold return line fluidly 170 connecting the radiator, or heat exchanger to the control valve; (j) an introduction line 180 fluidly connecting the control valve to the reservoir; (k) a temperature sensor 190 configured to sense a temperature of the coolant and (l) a controller 200 connected to the temperature sensor and the control valve, the controller and the control valve configured to selectively cycle coolant through the reservoir to the cab heat exchanger corresponding to a coolant temperature.

The present disclosure thus provides an all-electric powered coolant heater that can be installed on a natural gas tractor. The system can provide functionality including:

The user interface 240 having a one button touch on/off switch and multiple preset keypad in the cab; and

Presets in the controller 200 configured to allow an operator to set the electric heater 120 to come on prior to a dispatch time, such that the coolant is already up to temperature, and hence the cab is at temperature, when the operator starts their shift.

In one configuration, the electric heaters 120 and the reservoir 110 are configured to raise the temperature from a 40° F. start temperature to providing heat to the cab in 15 minutes (by heating just the volume of the reservoir 110, and full coolant system volume heat in 45 minutes. In one configuration, the electric heaters 120 and the reservoir 110 are configured to raise the temperature of the coolant in the loop between the reservoir and the truck heater core 20 (the cab) to 120° F. in 10 minutes.

It is further contemplated that the present system 100 can include an hour meter 102 for measuring the usage of the system. The hour meter 102 can be an independent meter connected to the controller 200 or the power supply 210, or can be integrated into the controller. Thus, the present system 100 can provide details of how often the electric heater 120 is being used by the operator.

As set forth above, the desired cab temperature can be maintained from the power supply 210 (such as the batteries) or an available AC source, such as residential or commercial grid, wherein the batteries can provide a DC with low voltage disconnect (LVD), wherein the LVD shuts off the electric heaters 120 before available power supply (such as battery power) is fully consumed.

It is further contemplated that the system 100 and particularly the controller 200 can include additional functions including but not limited to timing caps, and rechargeable battery management/health. A further configuration contemplates an app for remote monitoring and actuation and communicating through the wireless communication 250.

The controller 200 thus provides for an operator to preset a time/temperature for the cab. Thus, the present auxiliary electric heater 120 can be automatically turned on by the controller 200 at the start of a shift (or a givine time prior to start of the shift) and then when the driver starts the engine, the system 100, via the controller 200 and the pressure sensor automatically shuts off Other presets can include maintaining CNG engine 10 temperature above a predetermined level, prioritizing cab or engine temperature, as well as temperature thresholds for the initiation of the auxiliary electric heater 120. It is further contemplated the dwell time of the auxiliary electric heater 120 can be preset to predetermined lengths of operation. That is, the controller can be configured to provide for intermittent or cyclic operation of the electric heaters 120. In addition, the presets can include the specific temperature thresholds for actuation or termination of the auxiliary electric heater 120.

In one configuration, the controller 200 is configured to prioritize the heating of the cab. If the predetermined temperatures are obtained for the coolant circulating to the cab heat exchanger 30, the controller 200 can actuate the control valve 150 to include cycling the electrically heated coolant through the coolant jacket 12.

In a typical shut off scenario, the driver has been operating the vehicle for a delivery and thus the coolant is between 195° F. and 200° F. (and typically has a volume of 13 gallons). As soon as the oil pressure drop associated with the engine being turned off is sensed by the sensor 220, the controller 200 initiates operation of the pump 142 to circulate the relatively hot coolant through the engine coolant supply line 130, the line valve 132, the reservoir 110, then the pump 142 pass the coolant through the heated coolant supply 140, the cab heat exchanger 30, the cold return line 170, the control valve 150 and the introduction line 180 and/or engine coolant return line 160, as necessary to maintain the desired temperature in the cab. The electric heaters 120 are not actuated at this time.

Once the temperature sensor 190 detects a drop in the coolant temperature to a predetermined temperature, such as 160° F., (or the desired temperature in the cab is no longer supported by the available coolant temperature), the controller 200 powers the electric heaters 120 to begin to heat the coolant in the reservoir 110.

The present disclosure thus provides an all-electric auxiliary heating system 100 which does not generate any emissions and allows heated idle time, in otherwise restricted areas.

Configurations of the present disclosure encompass natural gas or propane-fueled vehicles that are over-the-road vehicles (i.e., Class 8), straight trucks (i.e., Classes 6 and 7), garbage trucks, trucks used to transport cargo, trucks used in the refuse industry, trucks used in the read-mix industry, and work trucks (service industry). Configurations of the present system encompass a motor vehicle having a liquid-cooled combustion engine having the coolant jacket 12 with ports for coolant to leave the coolant jacket and to return to the coolant jacket. All of these vehicles are characterized by the need to provide heat to a space, such as in the form of at least a passenger compartment, wherein the main power and heat source of such vehicle is turned off when the vehicle arrives at the destination, and reliance is placed on a supplemental source of thermal energy.

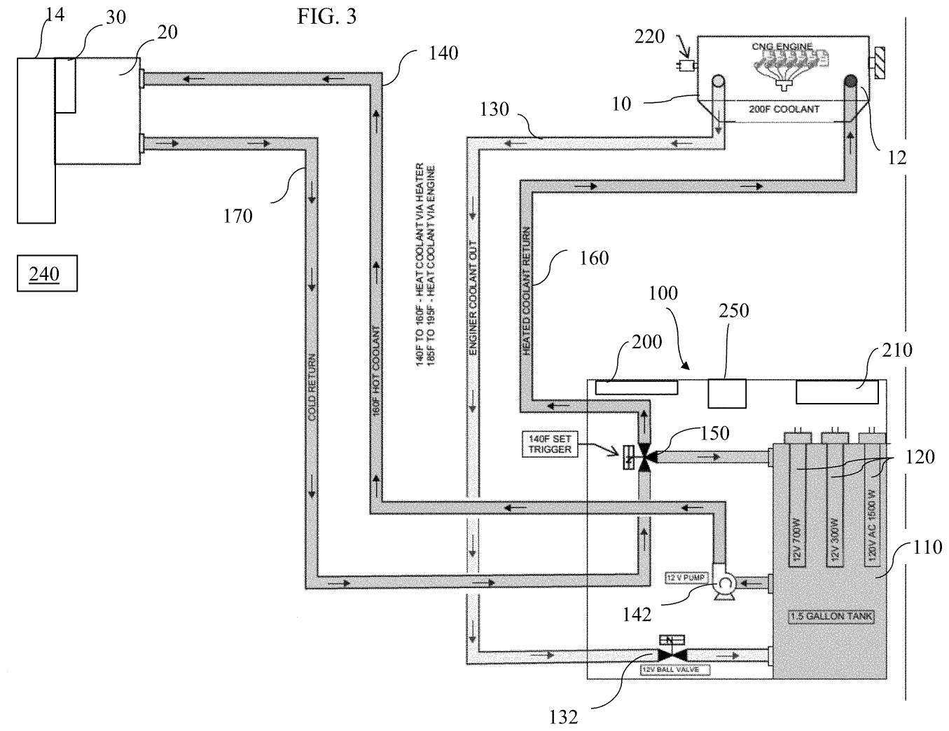

The electric heaters 120 of the present disclosure selectively use the on-board power supply or available grid power. In one configuration, the auxiliary heater 120 is sufficiently compact and contains components necessary to heat and circulate engine coolant while the engine 10 is off. Thus, the present system 100 and electric heater 120 are compact and can be packaged to utilize the space of the heater enclosure and to fit smaller vehicles. As seen in FIG. 3, the reservoir 110 and the electric heaters 120 can be mounted to permit access for servicing. The combination of the controller 200 and the electric heaters 120 provides heat at different selectable levels to maintain a set temperature. As set forth above, in one configuration, when heating the cab is required, the pump 142 initiates circulation of the coolant. Corresponding to predetermined coolant temperatures, the electric heaters 120 heat the coolant as it circulates through the reservoir 110, so that heated coolant flows to the cab heat exchanger 20 and coolant jacket 12 or the just the cab heat exchanger.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive.

1. An auxiliary heating system for a vehicle having a natural gas (NG) engine, a coolant jacket thermally coupled to the NG engine, a cab heat exchanger thermally connected to a cab, the auxiliary heating system comprising:
(a) a reservoir;
(b) an electric heater thermally coupled to the reservoir;
(c) an engine coolant supply line fluidly connecting the coolant jacket and the reservoir;
(d) a line valve in the engine coolant supply line;
(e) a heated coolant line fluidly connecting the reservoir to the cab heat exchanger;
(f) a pump fluidly connected to the heated coolant line to selectively transfer coolant from the reservoir to the heated coolant line and the cab heat exchanger;
(g) a control valve;
(h) an engine coolant return line fluidly connecting the control valve and the coolant jacket;
(i) a cold return line fluidly connecting the cab heat exchanger to the control valve;
(j) an introduction line fluidly connecting the control valve to the reservoir;
(k) a temperature sensor configured to sense a temperature of the coolant in at least one of the reservoir, the engine coolant supply line, the heated coolant line, or the cab; and
(l) a controller connected to the temperature sensor and the control valve, the controller configured to:
(i) cease operation of the pump upon the NG engine generating a predetermined oil pressure.

2. The auxiliary heating system of claim 1, wherein the NG engine is a compressed natural gas engine.

3. The auxiliary heating system of claim 1, wherein the controller is further configured to terminate operation of the pump in response to a predetermined coolant temperature.

4. The auxiliary heating system of claim 1, further comprising a second electric heater in the reservoir, wherein the second electric heater operates from a 120 volt electrical supply.

5. The auxiliary heating system of claim 1, wherein the controller includes a user interface comprising a touch pad.

6. The auxiliary heating system of claim 1, wherein the pump is a vane pump.

7. The auxiliary heating system of claim 1, wherein the cab heat exchanger is a component of a truck heater core.

8. The auxiliary heating system of claim 1, wherein the controller is configured to circulate coolant from the reservoir through the heated coolant line, the cab heat exchanger, the cold return line, the control valve and the introduction line.

9. The auxiliary heating system of claim 1, wherein the controller is configured to operate the control valve to simultaneously circulate coolant from the reservoir to the cab heat exchanger and the coolant jacket.

10. The auxiliary heating system of claim 1, further comprising an oil pressure switch operably connected to the NG engine and the controller.

11. The auxiliary heating system of claim 1, wherein the electric heater is in the reservoir.

12. The auxiliary heating system of claim 1, wherein circulation of coolant from the NG engine passes through the pump in an inoperative state of the pump.

13. The auxiliary heating system of claim 1, wherein a volume of the reservoir is between 10% and 25% of a total volume of coolant thermally exposed to the NG engine.

14. A method of heating a cab in a vehicle having a natural gas (NG) engine, a coolant jacket thermally coupled to the NG engine, and a cab heat exchanger thermally connected to the cab, the method comprising:
(a) sensing a temperature of a coolant heated by the NG engine;
(b) upon the sensed temperature dropping to a predetermined level, supplying electric power to an electric heater in a reservoir;
(c) actuating a pump fluidly connected to the reservoir to circulate the heated coolant to the cab heat exchanger; and
(d) setting the control valve to recirculate at least a portion of the coolant from the cab heat exchanger to the reservoir.

15. The method of claim 14, wherein a volume of the reservoir is between 10% and 25% of a total volume of coolant thermally exposed to the NG engine.

16. The method of claim 14, further comprising sensing an oil pressure in the NG engine and terminating supplying electric power to the electric heater in the reservoir in response to a predetermined oil pressure.
